(19) United States
(12) Patent Application Publication
(10) Pub. No.: US 2010/0199079 A1
(43) Pub. Date: Aug. 5, 2010

(54) ROUTER DEVICE

(75) Inventors: Akihito HIBI, Nagoya-shi (JP); Yoshiteru TAMURA, Nagoya-shi (JP)

Correspondence Address: Beyer Law Group LLP, P.O. BOX 1687, Cupertino, CA, 95015-1687, US

(73) Assignee: BUFFALO, INC., Nagoya-shi (JP)

(21) Appl. No.: 12/692,478

(22) Filed: Jan. 22, 2010

(30) Foreign Application Priority Data
Jan. 30, 2009 (JP) 2009-20253

(51) Int. Cl. G06F 1/28; G06F 9/24; G06F 9/44

(52) U.S. Cl. 713/2; 713/340; 717/168

(57) ABSTRACT

The router device is able to use either battery power or a commercial power supply, and when using battery power detects battery voltage and indicates the level of battery voltage with an LED. When the router device is using battery power, writing of the firmware is disabled. Further, writing of settings information write is disabled when battery voltage goes below a second threshold value; and supply of power to the CPU is subsequently interrupted when battery voltage goes below a first threshold value. In this way the router device of the invention avoids problems occurring due to a drop in battery voltage when using battery power.

### CROSS-REFERENCE TO RELATED APPLICATION

The present application claims priority from Japanese application P2009-20253A filed on Jan. 30, 2009, the content of which is hereby incorporated by reference into this application.

### BACKGROUND

1. Field of the Invention

The present invention relates to a router device adapted to forward communication packets between networks.

2. Description of the Related Art

Recent advances in networking technology have led to widespread adoption of mobile computing. In the field of router devices as well, compact products that are ultraportable have been developed. Devices designed to utilize secondary battery as the power supply can be contemplated as one type of such router device.

However, a number of issues stemming from the use of secondary battery are encountered in such router devices powered by secondary battery. For example, with secondary battery, when the remaining capacity drops, output voltage may rise or fall depending on operating conditions of the router device. If for a brief period the output voltage of the secondary battery should rise above or fall below the lower limit for voltage enabling the router device to operate, it is possible that a phenomenon whereby on/off switching of power to the router device occurs repeatedly. It is also conceivable that, when a drop in output voltage of the secondary battery occurs while the firmware saved in the memory of the router device is being updated, causing the power to go off while the contents of the memory are being rewritten, the firmware update may not be able to complete normally. In such instances it is possible that the firmware cannot be used normally, rendering the router device unusable.

### SUMMARY

With the foregoing in view, it is an object of the present invention to provide a router device powered by secondary battery, wherein problems caused by a drop in battery voltage may be prevented.

The above objects of the present invention may be attained according to the following aspects and embodiments of the invention.

A first aspect of the router device of the present invention comprises:

a battery connection portion adapted to connect to battery and to receive supply of power from the connected battery to the router device;

a detecting portion adapted to detect output voltage of the battery;

a indicator portion adapted to indicate a level of the detected output voltage; and

a power interrupt portion adapted to interrupt subsequent power supply from the battery when the detected output voltage has fallen below a first threshold value.

Because the router device of the above design detects the output voltage of the battery and displays the current level thereof, the user can ascertain output conditions of the battery and carry out procedures according to the remaining capacity of the battery. Specifically, procedures that would be likely to experience a problem if voltage should drop during operation can be avoided. Also, with this router device, when the output voltage of the battery falls below the first threshold value, the power supply is subsequently interrupted, thereby avoiding a situation in which a settings information or firmware overwrite is initiated with the battery at minimal remaining capacity, so that the power to the router device goes out while the operation is in progress. Moreover, once the power supply is interrupted, the power supply will subsequently remain interrupted, thereby avoiding frequent on/off switching of power to the router device even in instances where the output voltage of the battery fluctuates around the driving voltage of the router device.

Here, in another possible arrangement, the router device includes a settings information write-enable portion for enabling writing of settings information relating to the router device to a memory medium that has been provided to the router device, doing so only in instances where the detected output voltage is equal to or greater than a second threshold value. Because the router device of the above design will carry out writing of settings information only if the output voltage of the battery is equal to or greater than the second threshold value, a situation in which writing of settings information is initiated with the battery at minimal remaining capacity so that power to the router device goes out while the write operation is in progress can be avoided.

In another possible arrangement, the router device includes connection means adapted to connect to an AC adaptor and to receive supply of power from the connected AC adaptor. Because the router device of the above design can receive power supply from an AC adaptor, the router device can operate reliably even with the battery at minimal remaining capacity.

In yet another possible arrangement, the router device includes a firmware write-enable portion for enabling writing of firmware to a memory medium that has been provided to the router device, doing so only in instances where power is being supplied to the router device from the AC adaptor. Because a router device of the above design will carry out writing of firmware only if power supply is currently being received from the AC adaptor, a situation in which power to the router device goes out while the write operation is in progress and creates a problem can be avoided, even in instances where the firmware write operation requires a relatively long time.

In yet another possible arrangement, the router device employs a CPU and software to interrupt the power supply and accomplish the function of the power interrupt portion, and further includes a power interrupt circuit that, using hardware, will subsequently interrupt power supply from the battery when the detected output voltage has fallen below a third threshold voltage smaller than the first voltage.

With a router device of the above design, if the output of the battery falls below the third threshold voltage, the power supply can be subsequently interrupted using hardware, so that the power supply can be reliably interrupted even in the event of a software crash.

In yet another possible arrangement for any of these router devices, once the power interrupt portion has interrupted the power supply, the power supply will be restored only when the user carries out a prescribed manual operation on the router device. With a router device of this design, power will not be restored unless the user performs a manual operation, thereby avoiding repeated on/off switching of the power supply even if the output voltage of the secondary battery fluctuates around the first threshold value.

In yet another possible arrangement, the indicator portion performs the indication using a light-emitting device adapted to emit light of color according to the level of the output voltage. With a router device of this design, output power level is displayed through a color-coded display, whereby an easy-to-read display can be accomplished through a simple design.

There may be additionally provided a calibration portion adapted to perform calibration of output voltage detected by the detection portion. With a router device of this design, because calibration of output voltage is carried out, voltage detection accuracy can be improved and power supply control as described above can be carried out with good accuracy.

In yet another possible arrangement the router device additionally includes

a storage portion in which normal firmware subject to updating and backup firmware not subject to updating are stored so as to be independently runnable at startup of the router device;

a decision portion adapted to decide at startup whether the normal firmware is runnable; and

a run portion that run the backup firmware instead of the normal firmware according to the decision of the decision portion.

In a router device of this design, because both normal firmware and backup firmware are stored, if the normal firmware encounters a problem due for example by abnormal termination of router device operation during overwriting of the normal firmware, the backup firmware can be loaded instead, allowing the router device to be operated normally.

### BRIEF DESCRIPTION OF THE DRAWINGS

FIG. 1 is an illustration showing a simplified configuration of a router device;

FIG. 2 is an illustration showing a specific example of a relationship of discharge capacity and battery voltage of a secondary battery serving as a power supply for the router device;

FIG. 3 is a flowchart depicting the flow of an operation restriction process in the router device;

FIG. 4 is a flowchart depicting the flow of a firmware loading process in the router device; and

FIG. 5 is a flowchart depicting the flow of a firmware overwrite process in the router device.

### DESCRIPTION OF THE PREFERRED EMBODIMENTS

### A. Embodiment

The embodiment of the present invention will be discussed below.

A-1. Device Configuration:

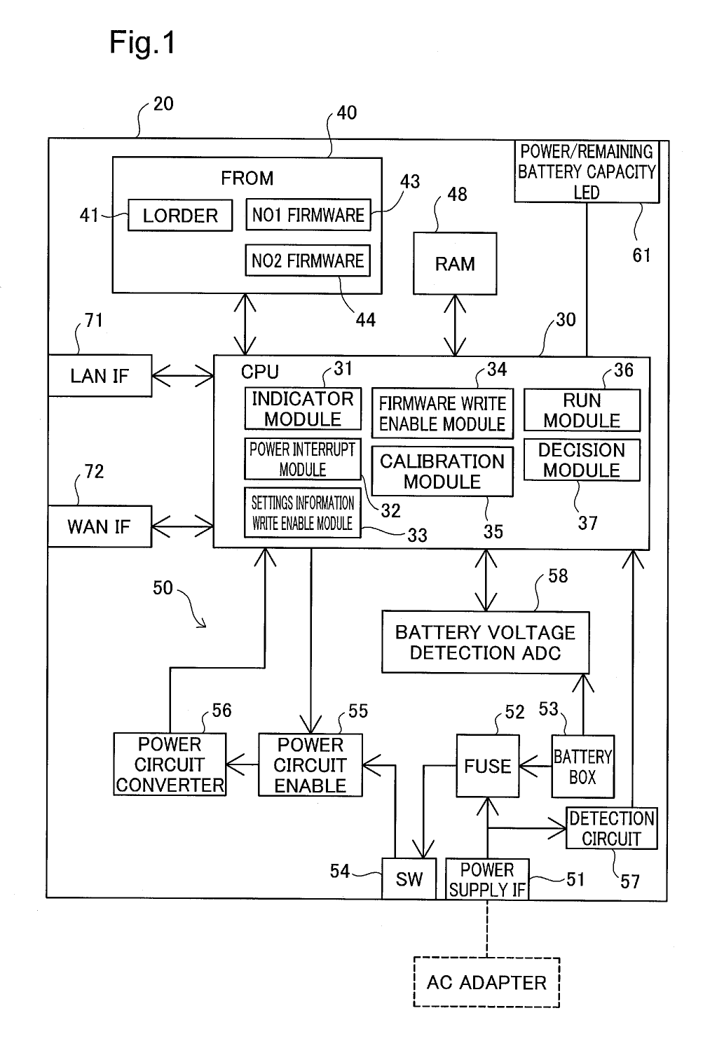

FIG. 1 depicts a simplified configuration of a router device 20 presented as an embodiment of the present invention. The router device 20 is one adapted to forward communication packets from a first network to a second different network. The router device 20 is furnished with a CPU 30, a flash ROM 40, RAM 48, a power control circuit 50, a Power/Remaining Battery Capacity LED 61, a LAN interface 71, and a WAN interface 72, these components being respectively connected by an internal bus.

The CPU 30 controls overall operation of the router device 20 by loading firmware or a program stored in the flash ROM 40 into the RAM 48, and executing the code. The CPU 30 also functions as a indicator module 31, a power interrupt module 32, a settings information write enable module 33, a firmware write enable module 34, a calibration module 35, a run module 36, and a decision module 37. These functions will be discussed in detail later.

The flash ROM 40 is a rewriteable, non-volatile storage medium in which have been saved a boot loader 41, first firmware 43, and second firmware 44. The boot loader 41 is a program that is read and executed first when the router device 20 is powered on, and loads either the first firmware 43 or the second firmware 44. The first firmware 43 is a program used under normal circumstances for control of the various hardware devices of the router device 20. The second firmware 44 is a backup program intended for use in place of the first firmware 43 when the first firmware 43 cannot function properly. The second firmware 44 is a minimal program making it possible to overwrite the first firmware 43, and as such is not intended to carry out the whole range of the operations of the router device 20, such as communication packet forwarding operations.

The power control circuit 50 is a circuit for controlling supply of power to the router device 20, and includes a power supply interface 51, a fuse 52, a battery box 53, a switch 54, an enable circuit 55, a converter circuit 56, a power detection circuit 57, and an analog-digital conversion circuit (ADC) 58 for battery voltage detection.

The power supply interface 51 is designed to connect to and receive supply of DC power from an AC-DC adapter which inputs AC power from a commercial power supply and outputs DC power; in the present embodiment, it receives 5 V DC power. The battery box 53 accommodates secondary battery and receives supply of power from the secondary battery. In the present embodiment, four rated 1.2 V nickel hydrogen storage battery (for a total of 4.8 V) were employed as the secondary battery in the battery box 53. That is, in the present embodiment, the router device 20 can use either the secondary battery or a commercial power supply as its power supply. In the present embodiment, ENELOOP™ batteries made by Sanyo Electric Co. Ltd. were used as the secondary battery.

The switch 54 is a slide switch that allows the user to manually switch on and off the power to the router device 20. The enable circuit 55 is a circuit for controlling the conditions under which the CPU 30 is supplied with power from either the power supply interface 51 or the battery box 53 via the fuse 52 and the switch 54; it includes a power supply IC, a latch, and a field effect transistor. Upon receiving a prescribed signal from the CPU 30, the enable circuit 55 will trip the latch, whereupon on the basis of the latch output the power supply IC will place the field effect transistor in the Off state, interrupting the supply of power to the converter circuit 56. The enable circuit 55 additionally includes an input voltage detection circuit. The enable circuit 55 has a circuit design such that a prescribed signal will be output to the latch, interrupting the supply of power in the manner described above, when detected voltage goes below a threshold value. The converter circuit 56 is a DC/DC converter; in the present embodiment, for output to the CPU 30 the input voltage is first converted to 3.3 V, which is the driving voltage of the router device 20.

The power detection circuit 57 is a circuit designed to detect whether power is being supplied via the power supply interface 51, and to output the result to the CPU 30. The battery voltage detection ADC 58 is a circuit for digital conversion of the analog output voltage of the secondary battery installed in the battery box 53, for output to the CPU 30. In the present embodiment, the battery voltage detection ADC 58 has 8-bit resolution. Additionally, upon entering calibration mode in response to a user operation, it will be possible by way of a process of the calibration module 35 for the CPU 30 to perform calibration of detected voltage by the battery voltage detection ADC 58. As a specific example, on the basis of a signal from the CPU 30, the battery voltage detection ADC 58 will detect its detected voltage in response to a known input voltage provided by a reference voltage generating circuit which has been furnished to the battery voltage detection ADC 58, and will then compute offset and gain correction values, and save these to a storage medium which has been furnished to the battery voltage detection ADC 58. Subsequently, the battery voltage detection ADC 58 will correct its detection values based on these saved correction values. This calibration may also be performed when the unit is shipped from the factory. A configuration whereby the battery voltage detection ADC 58 is incorporated into the CPU 30 would be acceptable as well.

The Power/Remaining Battery Capacity LED 61 is an LED adapted to display the level of output voltage of the secondary battery on the basis of voltage which has been detected by the battery voltage detection ADC 58; in the present embodiment, it is capable of displaying three different colors, namely, green, orange, and red.

The LAN interface 71 is an interface for connection to a local area network (LAN); in the present embodiment, it is a wireless LAN port compliant with IEEE 802.11b/g networking standards. The WAN interface 72 is an interface for connection to a wide area network (WAN); in the present embodiment, it is a slot for a PHS network card.

A-2. Secondary Cell Characteristics

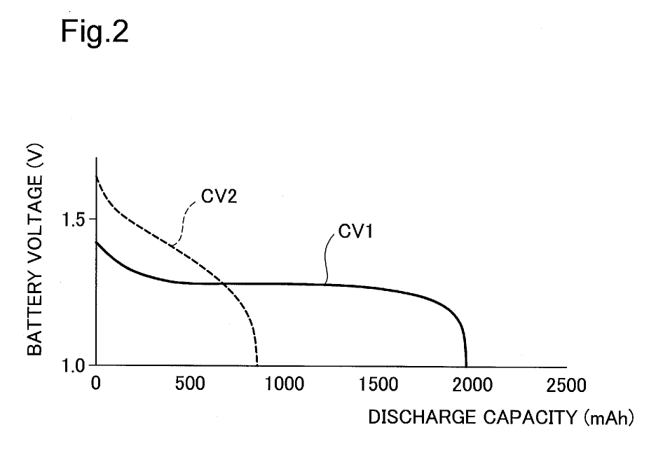

The characteristics of the secondary battery employed as a power supply for the router device 20 in the present embodiment will be discussed with reference to FIG. 2. FIG. 2 is an illustration showing a specific example of relationships between discharge capacity and battery voltage for a secondary battery (rated 1.2 V) and for a manganese dry cell (rated 1.5 V). The characteristics shown were obtained with continuous discharge of 500 mA at 25° C. As shown by the plot CV2, with regard to battery voltage of the manganese dry cell, beginning immediately after initiating service battery voltage declines at a generally constant slope in association with increasing discharge capacity, falling to 1.0 V before discharge capacity reaches 1000 mAh.

On the other hand, as shown by the plot CV1, while a drop in battery voltage of the secondary battery is observed immediately after being placed in service, after dropping to approximately the rated voltage (1.2 V), despite increasing discharge capacity the voltage remains substantially at rated voltage level as discharge proceeds, and at the point in time that discharge capacity reaches around 2000 mAh, drops precipitously to 1.0 V. In this way, as compared to a primary battery, a secondary battery exhibits a greater rate of drop in output starting from the time that a prescribed level of battery voltage has been consumed.

A-3. Operation Restriction Process:

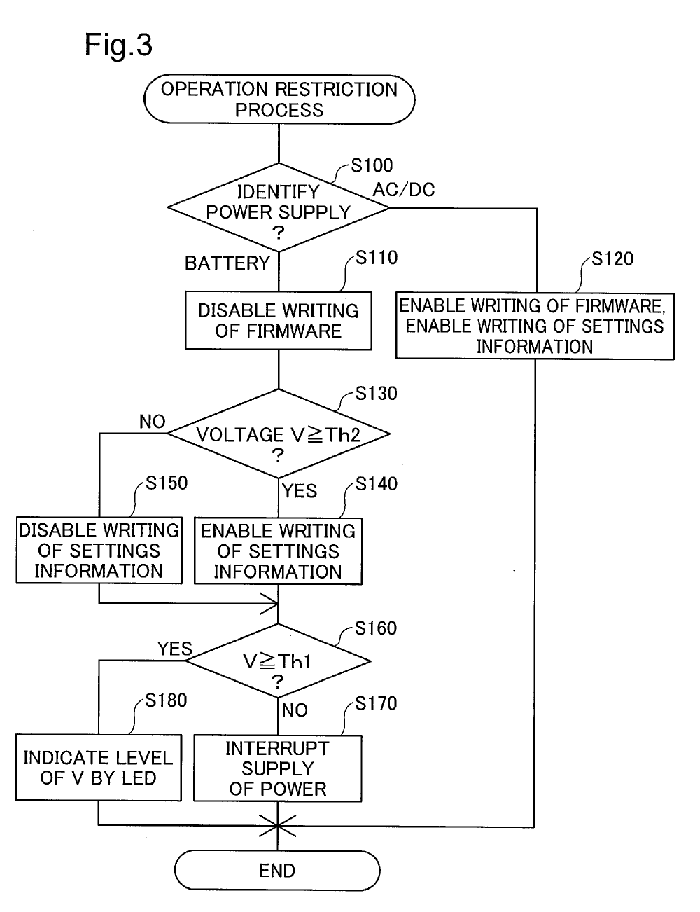

The operation restriction process of the router device 20 will be described with reference to FIG. 3. This operation restriction process is one whereby, depending on conditions of power supply to the router device 20, various operations in the router device 20 are restricted. This process is executed in parallel with the packet forwarding process, which is a normal operation of the router device 20. In the present embodiment, when the user connects the AC-DC adapter to the power supply interface 51 or installs secondary battery in the battery box 53 and turns the switch 54 to the ON position, the CPU 30 initiates a prescribed initialization process, and the operation restriction process will be initiated upon completion of this initialization process.

When the operation restriction process is initiated, the CPU 30 will decide upon the type of power supply for the router device 20 (Step S100). The present embodiment is designed such that if the AC-DC adapter has been connected to the power supply interface 51 and at the same time secondary battery has been installed in the battery box 53, preference will be given to the AC-DC adapter power supply; if the power detection circuit 57 has detected supply of power from the AC-DC adapter, it will be decided that the power supply for the router device 20 is the AC-DC adapter, or if supply of power from the AC-DC adapter is not detected, it will be decided that the power supply for the router device 20 is the battery power supply.

As a result, where the power supply for the router device 20 is the AC-DC adapter, by way of a process of the firmware write enable module 34, the CPU 30 will enable firmware write processes and settings information write processes to the flash ROM 40 (Step S120), then terminate the process. Settings information refers to settings information of various kinds relating to router device 20 operation, for example, IP address, SSID, filtering settings, and so on. Entering this enabled state will allow the user to overwrite and update the first firmware 43 which is stored in the flash ROM 40, doing so for example using a Web browser from a personal computer that is connected to the router device 20 via the LAN interface 71. It will also be possible for the user to update the settings information stored in the flash ROM 40, using a Web browser as described above.

On the other hand, where the power supply for the router device 20 is the secondary battery, by way of a process of the firmware write enable module 34, the CPU 30 will prohibit firmware write processes to the flash ROM 40 (Step S110). The reason for prohibiting the write process during operation on battery power supply is that the firmware write operation is one requiring a relatively extended time period, and if battery voltage should drop during the firmware write operation so that the write operation is interrupted while in progress, there is a risk that the firmware cannot be restored, and that the router device 20 will subsequently become inoperable.

Having prohibited writing of firmware, the CPU 30 will then decide whether the detected voltage V output by the battery voltage detection ADC 58 is equal to or greater than a threshold value Th2 (Step S130). The threshold value Th2 corresponds to the second threshold value in the present invention.

As a result, if the detected voltage V is equal to or greater than the threshold value Th2 (Step S130: YES), by way of a process of the settings information write enable module 33, the CPU 30 will enable writing of settings information to the flash ROM 40 (Step S140). The reason for enabling writing of settings information as long as voltage at or above a prescribed level is detected, even when the device is running on battery power, is that it is possible for a settings information write operation to be executed within a relatively short time period as compared with writing of firmware, and thus the write operation can be completed before the battery voltage drops to a level at or below the driving voltage of the router device 20.

On the other hand, if the detected voltage V is less than the threshold value Th2 (Step S130: NO), by way of a process of the settings information write enable module 33, the CPU 30 will prohibit writing of settings information (Step S150). The reason for prohibiting settings information write processes below a prescribed voltage in this way is that if battery voltage should drop during a settings information write operation causing the write operation to be interrupted while in progress, the settings data may be determined to be improper data, thus requiring measures such as a reset of the settings through initialization.

In the present embodiment, the threshold value Th2 has been set to 4.5 V; the reason for doing so is that when output voltage reaches about 1.12 V (4.48 V for four batteries), the secondary battery used in the present embodiment begin to experience a faster rate of drop in output voltage. It will be preferable to set this threshold value appropriately with reference to factors such as the time required to write the settings information, the secondary battery characteristics (e.g. output voltage drop characteristics and voltage fluctuation characteristics), the number of secondary battery being used, and the magnitude of the differential between the threshold value and the driving voltage of the router device 20, to arrive at a value such that the settings information write operation can complete reliably.

Once restriction of writing of settings information has been set up in this way, the CPU 30 will then decide whether the detected voltage V is equal to or greater than a threshold value Th1 (threshold value Th2>threshold value Th1) (Step S160). The threshold value Th1 corresponds to the first threshold value in the present invention.

As a result, if the detected voltage V is equal to or greater than the threshold value Th1 (Step S160: YES), by way of a process of the indicator module 31, the CPU 30 will light up the Power/Remaining Battery Capacity LED 61 with a color that corresponds to the detected voltage V (Step S180) in order to indicate the detected voltage V level, and will then terminate the process. In the present embodiment, if detected voltage is 4.8 V or above the Power/Remaining Battery Capacity LED 61 will light up green; if 4.5 V or above but less than 4.8 V it will light up orange; and if 4.2 V or above but less than 4.5 V it will light up red. The method for indicating the detected voltage V level may be established appropriately, for example, by using a two-color or four-color indication scheme; by indicating level through the on/off status of several LEDs; or by displaying the detection value, or estimated battery remaining capacity based on the detection value, on a liquid crystal panel or the like.

On the other hand, if the detected voltage V is less than the threshold value Th1 (Step S160: NO), by way of a process of the power interrupt module 32, the CPU 30 will send a prescribed signal to the enable circuit 55 and subsequently interrupt the supply of power to the converter circuit 56 (Step S170). Once the supply of power has been interrupted in this way, the operation restriction process will terminate. This operation restriction process is executed repeatedly at prescribed intervals.

In the present embodiment, the threshold value Th1 has been set to 4.2 V; the reason for doing so is that when output voltage reaches about 1.05 V (4.2 V for four batteries), the secondary battery in the present embodiment experience a very fast rate of drop in output voltage. As with the threshold value Th2, it will be preferable to set the threshold value Th1 appropriately with reference to various factors, to a value such that the output of the secondary battery will not fall below the driving voltage of the router device 20, even transitorily.

Once the supply of power has been interrupted in Step S170 as described above, in the router device 20 the supply of power will not subsequently resume unless the user manually first turns the switch 54 to the Off position and then to the On position. In the present embodiment, the enable circuit 55 has been designed such upon receiving from the switch 54 a Reset signal input through this on/off procedure, the field effect transistor will be switched On via the latch and the power supply IC so that supply of power can begin.

The arrangement by which the supply of power is restored is not limited to that described in the example above; in another possible arrangement for example, the router device 20 may be provided with a reset button for restoring power, enabling the user to press the button to restore the power. That is, an arrangement whereby power can be restored only by a manual procedure by the user is preferred. With such arrangements, because power will not be restored unless the user performs a manual procedure, even if the output voltage of the secondary battery fluctuates around the threshold value Th1, the power will not switch on and off repeatedly. Another reason is higher reliability, since the router device 20 will not restart contrary to the wishes of the user. Another advantage is increased convenience, because once the user has replaced the secondary battery or connected the AC-DC adapter to the router device 20, the router device 20 can be started up again simply by performing on/off operation of the switch 54.

As discussed above, when detected voltage has fallen below a threshold value, the enable circuit 55, using hardware, will interrupt the supply of power to the CPU 30. In the present embodiment, this threshold value Th3 has been set to 3.5 V. The threshold value Th3 corresponds to the third threshold value in the present invention. The threshold value Th3 may be set to any value that is less than the aforementioned threshold value Th1, but greater than the driving voltage of the router device 20. By adopting such an arrangement, even if conditions such that the CPU 30 cannot control operation of the router device 20 should arise due to an event such as a software crash for example, i.e. even if conditions are such that the supply of power cannot be interrupted in Step S170, the supply of power can be subsequently interrupted in response to a drop in detected voltage V.

A-4. Firmware Loading Process:

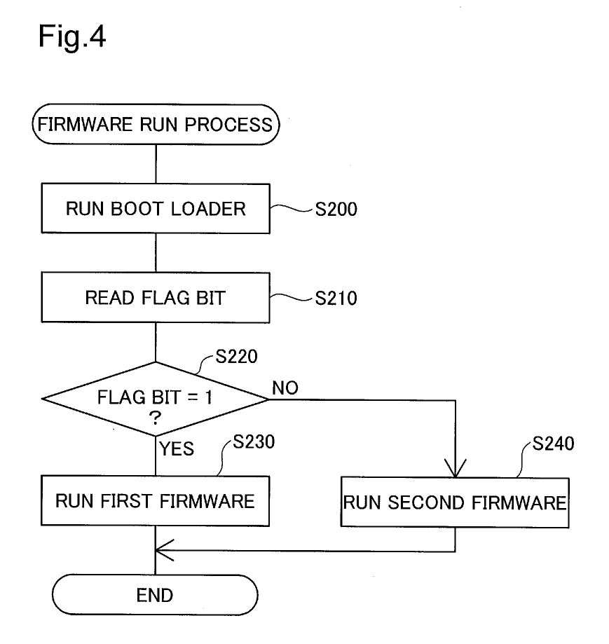

The firmware loading process of the router device 20 will be described with reference to FIG. 4. Here, the firmware loading process refers to the initial process of a system initialization process enabling the operation restriction process described above, as well as communication packet transfer processes that take place once the router device 20 has established connection with the LAN and the WAN, to be carried out subsequently. In the present embodiment, the firmware loading process is initiated when the user turns the switch 54 to On.

Once the firmware loading process has been initiated, first, the CPU 30 will load and run the boot loader 41 which has been stored in the flash ROM 40 (Step S200). With the boot loader 41 running, by way of a boot loader 41-directed process by the decision module 37, the CPU 30 will read a flag bit that has been allocated to a prescribed area of the flash ROM 40 (Step S210) and decide whether the flag has a value of “1” (Step S220). This flag indicates whether the first firmware 43 for normal use is runnable or not; in the present embodiment, if the flag indicates a value of “1” this indicates a condition in which the first firmware 43 is runnable. The flag bit is set to the value “1” by default, but may be overwritten in a firmware update process, to be discussed later. The method for overwriting the flag bit will be described later.

As a result, if the flag has a value of “1” (Step S220: YES), because it is possible for the first firmware 43 to be loaded, by way of a boot loader 41-directed process of the run module 36, the CPU 30 will load and run the first firmware 43 (Step S230). With the first firmware 43 running, it will be possible to execute the communication packet forwarding processes and the aforementioned operation restricting process of the router device 20.

On the other hand, if the flag has a value of “0” (Step S220: NO), because conditions are such that the first firmware 43 is not runnable, by way of a boot loader 41-directed process of the run module 36, the CPU 30 will load and run the backup second firmware 44 in place of the normal first firmware 43 (Step S240). When the second firmware 44 is run in this way, the router device 20 will assume in a state in which routing operations are disabled but overwriting of the first firmware 43 is enabled. Consequently, provided that the CPU 30 is able to successfully carry out overwriting of the first firmware 43 by a firmware overwrite process (discussed later) based on user operation, the flag will be returned to a value of “1” (discussed in detail later), making it possible to subsequently run the first firmware 43.

Overwriting of the flag bit as described above is carried out during the first firmware 43 overwrite process. The method of overwriting the flag bit will be described below in terms of the first firmware 43 overwrite process. In the present embodiment, the first firmware 43 overwrite process is initiated when the user, using a Web browser, performs a firmware overwrite instruction procedure from a personal computer which is connected to the router device 20 via the LAN interface 71.

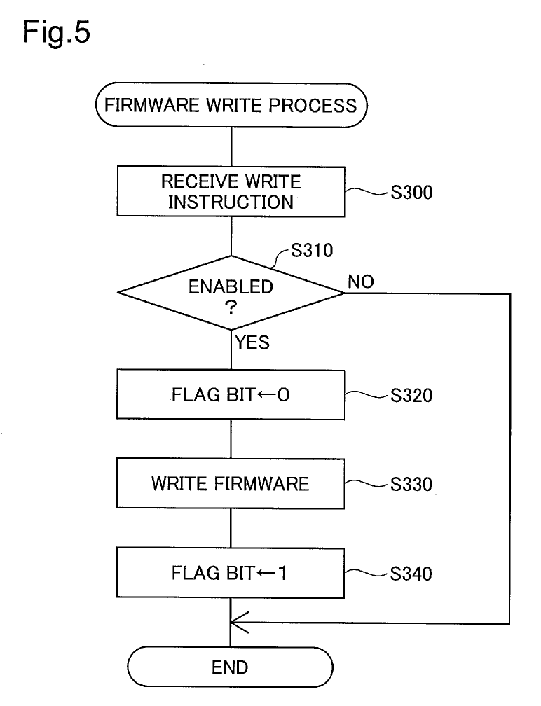

As depicted in FIG. 5, when the first firmware 43 overwrite process is initiated, the CPU 30 will receive an overwrite instruction provided to it via the Web browser (Step S300), and will then decide whether writing of the first firmware 43 is enabled (Step S310). The enabled state has been established in Step S120 of the operation restriction process discussed earlier.

As a result, if writing is not enabled (Step S310: NO), i.e. if the current power supply for the router device 20 is the battery power supply, writing of the firmware cannot take place, and therefore the CPU 30 will terminate the process.

On the other hand, if writing is enabled (Step S310: YES), i.e. if the current power supply for the router device 20 is the AC-DC adapter, the CPU 30 will overwrite the value of the flag bit to “0” (Step S320). The CPU 30 will then perform overwriting of the firmware (Step S330), and if overwriting terminates normally, will return the value of the flag bit to “1” and terminate the process.

In the course of overwriting the firmware, in the event that overwriting of the firmware in Step S330 fails to terminate normally due for example to the AC-DC adapter becoming unplugged from the power supply interface 51 or to a power outage, the flag bit will remain at “0”, so during the next firmware run process the CPU 30 will run the second firmware 44 (Step S240). Then, when the second firmware 44 is run, the firmware overwrite process will take place as described above, so provided that the CPU 30 was able to successfully carry out overwriting of the first firmware 43 based on user operation, the flag will be returned to a value of “1” in the aforementioned step S340.

The router device 20 having the design in question is adapted to use the battery voltage detection ADC 58 to detect output voltage of the secondary battery installed in the battery box 53, and to light up the Power/Remaining Battery Capacity LED 61 with a color corresponding to the value of the detected voltage V to indicate the level of the detected voltage V, so that the user can ascertain output conditions of the secondary battery and carry out procedures according to remaining capacity of the battery. For example, from the point in the time that user becomes aware that the secondary battery have low remaining capacity, he or she may opt to avoid operations such as writing of settings information, and as a result, avoid situations in which the router device 20 runs out of power while the operation is in progress. Also, when the detected voltage V falls below the threshold value Th1, the router device 20 will send a prescribed signal to the enable circuit 55 and subsequently interrupt the supply of power to the CPU 30, thereby avoiding situations in which an operation such as writing of settings information is initiated under conditions of minimal remaining capacity of the battery so that power to the router device 20 is cut off while the operation is in progress. Moreover, because the supply of power subsequently remains interrupted once the detected voltage V falls below the threshold value Th1, frequent on/off switching of power to the router device will not take place, even in instances where the output voltage of the battery fluctuates around the driving voltage of the router device 20.

Additionally, because the router device 20 performs writing of settings information only when the detected voltage V is equal to or greater than the threshold value Th2, that is, because this write operation is prohibited when remaining battery capacity is very low, problems that might arise if power to the router device 20 cuts out during a write operation can be avoided.

Further, because the router device 20 can be supplied with power from an AC-DC adapter via the power supply interface 51, the router device can be operated in a reliable manner even if remaining battery capacity is very low, so provided that a commercial power supply is available at the location, problems arising when power to the router device 20 runs out during operation of the router device 20 can be avoided.

Additionally, because a firmware write operation will take place only when the router device 20 is being supplied with power from the AC-DC adapter, problems arising when power to the router device 20 runs out during a write operation can be avoided, even during a firmware write operation which requires a relatively long period of time to complete.

As shown by the embodiment herein, the working effects of the router device 20 described above will be particularly notable in instances where secondary battery having the characteristic of a fast rate of drop in battery output voltage starting from a point in time of given usage are employed as the power supply for the router device 20.

Also, because the router device 20 is designed so that if the detected voltage V falls below the third threshold value Th3 the supply of power can be subsequently interrupted through hardware means by the enable circuit 55, the supply of power can be reliably interrupted even in the event of a software crash.

Moreover, because the router device 20 performs calibration of the detected voltage V, detection accuracy of the detected voltage V can be improved, and control of the supply of power as described above can be carried out with good accuracy.

Additionally, the router device 20 has been designed so that in the firmware overwrite process, the firmware overwrite is performed after first having set the value of the flag bit to “0”, and the flag bit is returned to the value of “1” only when the overwrite terminates normally. Also, during the firmware run process, if the value of the flag bit is “1” the router device 20 will run the normal first firmware 43, whereas if the value of the flag bit is “0” it will run the backup second firmware 44. Thus, even if an update of the first firmware 43 is interrupted in progress due for example to the AC-DC adapter becoming disconnected during updating of the first firmware 43, creating a situation in which the first firmware 43 cannot be recovered, the second firmware 44 can be run instead, allowing the first firmware 43 to be overwritten and the value of the flag bit to be returned to “1”, thereby making it possible to run the first firmware 43 in the next firmware run process, and to restore the router device 20 to normal operation.

Furthermore, because the second firmware 44 has been designed to accomplish only the minimum necessary functionality, namely, the firmware overwrite process, the finite capacity of the flash ROM 40 can be utilized more efficiently, or the capacity of the flash ROM 40 can be smaller, as compared to where the second firmware 44 has functionality comparable to the first firmware 43. However, the second firmware 44 may instead be designed to provide functionality comparable to the first firmware 43. These arrangements can address the problem of inability of the router device to operate normally following an event in which the router device firmware overwrite process fails to complete normally.

### B. Modifications

B-1: Modification 1:

In the present embodiment, there was employed a design whereby both battery power and a commercial power supply may be utilized as the power supply for the router device 20, a design in which only battery power is used may be adopted instead. The battery power supply is not limited to the nickel hydrogen storage battery shown in the embodiment, and various kinds of secondary battery, such as lithium ion secondary battery, can also be used. Nor is the battery power supply inherently limited to second battery, and various kinds of primary battery, fuel battery, and the like can also be used. With regard to commercial power supplies as well, the device is not limited to a design supplied with power by an AC-DC adapter; in another possible design, the router device 20 may be furnished for example with a USB interface, and supplied with bus power via an information processing device of the like that is powered by a commercial power supply.

B-2: Modification 2:

In the embodiment set forth above, the router device 20 has been designed so that if the detected voltage V falls below a prescribed value, various operations will be restricted immediately; however, the timing for restricting operations is not limited to such an arrangement. For example, in another possible design, when the detected voltage V has fallen below a prescribed value, the CPU 30 will acquire the operational status of the router device 20 by recognizing an operation flag or the like; and if it finds that a write operation of settings information etc. is in progress, it will perform restriction of operations only after the operation in question has terminated. In an alternative design, restriction of operations may take place after a prescribed period of time has elapsed since first detecting that the detected voltage V is less than a prescribed value. By so doing, even if the detected voltage V should fall below a prescribed value in the final stage of a write operation for example, restriction of operations may be performed after the write operation has terminated normally.

B-3: Modification 3:

In the embodiment above, the second firmware 44 is stored in the flash ROM 40, but may instead be stored in non-rewriteable ROM or the like. By so doing the user cannot inadvertently overwrite the second firmware 44 so that continued functionality of the second firmware 44 as backup firmware may be assured.

While the present invention has been described in terms of preferred embodiments, it is to be understood that the invention is not limited to these embodiments and as a matter of course may otherwise be reduced to practice in various modes. For example, it is possible to combine only certain selected elements from those shown in the above embodiments and modifications.

What is claimed is:

1. A router device comprising:
a battery connection portion adapted to connect to a battery and to receive supply of power from the connected battery to the router device;
a detecting portion adapted to detect output voltage of the battery;
an indicator portion adapted to indicate the level of detected output voltage; and
a power interrupt portion adapted to interrupt subsequent power supply from the battery when the detected output voltage has fallen below a first threshold value.

2. The router device according to claim 1 further comprising a settings information write-enable portion for enabling writing of settings information relating to the router device to a memory medium that has been provided to the router device, doing so only in instances where the detected output voltage is not smaller than a second threshold value.

3. The router device according to claim 1 further comprising an adapter connection portion adapted to connect to an AC adaptor and to receive supply of power from the connected AC adaptor.

4. The router device according to claim 3 further comprising
a firmware write-enable portion for enabling writing of firmware to a memory medium that has been provided to the router device, doing so only in instances where power is being supplied to the router device from the AC adaptor.

5. The router device according to claim 1:
wherein the power interrupt portion includes a CPU that, executing prescribed software, interrupts the power supply;
and further comprising a power interrupt circuit that, using hardware, interrupts power supply from the battery once the detected output voltage has fallen below a third threshold voltage smaller than the first threshold voltage.

6. The router device according to claim 1, wherein once the power interrupt portion has interrupted the power supply, a prescribed manual operation on the router device is required to restore the power supply.

7. The router device according to claim 1, wherein the indicator portion performs the indication using a light-emitting device adapted to emit light of color according to the level of the output voltage.

8. The router device according to claim 1 further comprising a calibration portion adapted to perform calibration of output voltage detected by the detection portion.

9. The router device according to claim 1 further comprising:
a storage portion in which normal firmware subject to updating and backup firmware not subject to updating are stored so as to be independently runnable at startup of the router device;
a decision portion adapted to decide at startup whether the normal firmware is runnable; and
a run portion that run the backup firmware instead of the normal firmware according to the decision of the decision portion.

10. A router device comprising:
a power supply portion using battery and adapted to supply the router device with power for operation;
a storage portion in which normal firmware subject to updating and backup firmware not subject to updating are stored so as to be independently runnable at startup of the router device;
an update portion adapted to perform updating of the normal firmware;
a decision portion adapted to decide at startup whether the normal firmware is runnable; and
a run portion that run the backup firmware instead of the normal firmware according to the decision of the decision portion.
